(19) United States
(12) Patent Application Publication
(10) Pub. No.: US 2026/0262833 A1
(43) Pub. Date: Sep. 10, 2026

(54) Device for ejecting a movable furniture part

(71) Applicant: Samet Kalip Ve Madeni Esya San Ve Tic. A.S., Istanbul (TR)

(72) Inventors: Christian Prentner, Götzis (AT); Nurettin Güzeltepe, Istanbul (Avrupa Yakasi) (TR); Hatice Gedik, Istanbul (TR)

(21) Appl. No.: 18/871,879

(22) PCT Filed: Aug. 15, 2022
(86) PCT No.: PCT/TR2022/050857

§ 371 Date: Dec. 5, 2024

(51) Int. Cl. A47B 88/463; E05C 19/02

(52) U.S. Cl. CPC A47B 88/463; E05C 19/022

(57) ABSTRACT

The invention relates to a device (1) for ejecting a movable furniture part, wherein the device (1) comprises a housing (9) and a carriage (30) movable relative to the housing (9), wherein the carriage (30) is movable between a retracted position and an ejected position, wherein a trigger (90) is provided which is movable between a blocking position and a release position, wherein actuation of the trigger (90) into the release position releases a movement of the carriage (30) from the retracted position. A simple design and increased ease of operation are achieved in that the carriage (30) comprises a pusher (50), in that the pusher (50) is movable relative to the carriage (30), in that the pusher (50) comprises the driver stop (51) and in that the trigger (90) can be actuated by moving the pusher (50) from a rest position to an adjustment position.

The invention relates to a device for ejecting a movable furniture part, wherein the device is designed to effect and/or support the ejection by force transmission between a driver stop of the device and a driver, wherein the device comprises a housing and a carriage movable relative to the housing, wherein the carriage is movable between a retracted position and an ejected position, wherein a trigger is provided which is movable between a blocking position and a release position, wherein actuation of the trigger into the release position releases a movement of the carriage from the retracted position.

A device of this type is known from EP 3 133 230 A1. The device comprises a base plate on which an ejector in the form of a carriage is mounted in a linearly movable manner. A contact section is provided on the ejector, which serves as a driver stop. The device further comprises a force accumulator in the form of springs which are mounted in a pretensionable manner between a fixed bearing and a motion element. In a closed state of the movable furniture part, the device is in a tensioned state. The ejector is then in a retracted position. To eject the movable furniture part, this tensioned state may be released. A movable trigger is provided on the base plate for this purpose. An overstroke may be achieved by a user acting on the movable furniture part in the closing direction when the closed furniture part is in the closed position. In this case, the ejector is moved beyond the retracted position, with a contact section of the ejector at least partially transmitting the force acting on the movable furniture part to the trigger. This causes the trigger to be moved relative to the base plate. The movement of the trigger causes a flap to pivot about an axis of rotation, thereby releasing a locking member of the device from the flap. When the locking member is released, movement of the ejector from retracted position is enabled.

A disadvantage of the known device is that the ejector must be moved to actuate the trigger. This means that the ejector must be movable beyond the retracted position to allow an overstroke. On the one hand, this may lead to an undefined haptic and/or acoustic feedback to the user, since there is no final end position of the trigger in the retracted position. Thus, the ease of use and/or the impression of sophistication of the device may be limited.

Secondly, the movability of the ejector beyond the retracted position must be structurally coordinated with other components of the device. In other words, the movement of the driver stop required to trigger the overstroke must be appropriately decoupled from the other functions of the device, in particular from the ejection movement and/or a change in the pretension of the force accumulator. According to the known device, the ejector in the retracted position is in a free-running state for this purpose, in which it is decoupled from the force accumulator. Accordingly, the ejector is not in contact with the force accumulator at the time the trigger is released. If contact is now re-established between the ejector and the force accumulator to carry out an ejection process, this may result in undesirable noise generation and/or increased mechanical stress on the contact partners involved.

It is the task of the invention to provide a device of the type mentioned above, which is characterized by a simple design and increased ease of operation.

This task is solved by providing that the carriage comprises a pusher, that the pusher is movable relative to the carriage, that the pusher comprises the driver stop, and that the trigger can be actuated by moving the pusher from a rest position to an adjustment position.

An overstroke, i.e. an acting on the movable furniture part in the closing direction beyond a closed position, can be at least partially transmitted to the pusher by means of the contact between the driver and the driver stop. The overstroke can then be further transmitted from the pusher to the trigger at least partially, thereby actuating the trigger. A rest position of the pusher may correspond to a situation in which no overstroke acts on the movable furniture part. The pusher may be movable relative to the carriage, for example, in the direction towards the trigger. When an overstroke acts on the movable furniture part, the pusher may be moved to the adjustment position. In the adjustment position, the pusher may be in contact with the trigger and, for example, transmit a force and/or a movement, in particular the overstroke to the trigger. The trigger may thus be moved from the blocking position to the release position.

The carriage therefore does not have to be moved to actuate the trigger, but may remain in a defined position in the retracted position, for example at a stop. In particular, it is not necessary for the carriage to be moved when an overtravel is exerted on the movable furniture part. On the one hand, this enables a defined position of the carriage during the overstroke movement. On the other hand, the required travel of the carriage is reduced. Also, the carriage does not have to be decoupled from other components of the device, in particular not from any energy store that may be provided, for example from a spring element.

The pusher may, for example, be provided in a linearly movable manner on the carriage. In particular, a linear movement of the pusher relative to the carriage may be parallel with an overstroke movement. It is conceivable that the trigger is also linearly movable. The trigger may, for example, be mounted on the housing so as to be linearly movable. Advantageously, the movement directions of the pusher and the trigger may be aligned in parallel.

If it is provided that the pusher comprises an actuating surface, that the actuating surface forms the driver stop, that the pusher comprises a pushing surface opposite the actuating surface, and that the pushing surface is designed for actuating the trigger, the overstroke may be transmitted to the trigger in a simple and reliable manner.

According to an advantageous embodiment of the invention, it is proposed that the pusher is mounted on the carriage in a pretensioned manner, and that the pretensioning counteracts an movement of the trigger from the rest position into the adjustment position. In this way, it may be ensured that the pusher is returned to its rest position after adjustment, in particular after the end of an overstroke and/or after actuation of the trigger. The amount of force of the pretensioning of the pusher on the carriage may also be designed to specifically influence a required operating force that is needed, for example, to effect the overstroke and/or to actuate the trigger.

A variant of the invention may be characterized in that the pusher comprises a spring bearing and a spring abutment, that the pusher comprises a spring, that the spring is supported on the spring bearing with a first spring end, and in that the spring is held in the region of the spring abutment with a second spring end. By means of a spring, a pretensioning of the pusher with respect to the carriage may be realized in a simple manner. The pusher may be easily preassembled by inserting the spring between the spring bearing and the spring abutment. The fact that the spring is supported on the spring bearing means that an acting force, for example due to an overstroke, may be reliably transmitted to the spring. Likewise, a reliable return of the pusher from the adjustment position to the rest position may be caused and/or supported by the spring.

If it is further provided that the spring projects at least partially and/or regionally beyond the spring abutment in the region of the second spring end, an accessible region is created on the spring, for example in order to exert a force on the spring. A force on the spring may, for example, be caused by the carriage when the pusher is moved. In this way, the spring may be displaced away from the spring abutment with its second spring end, in particular while increasing its pretension.

In this context, it may be provided in particular that the spring abutment comprises a transverse extension which is less than a parallel transverse extension of the spring in the region of the second spring end. This results in accessibility of the spring in the area of the second spring end, for example, to both sides of the spring abutment.

This may be achieved particularly easily if it is provided that the spring is a helical spring. In this case, the outer diameter of the spring in the area of the second spring end may preferably be larger than the transverse extension of the spring abutment.

It may also be provided that the spring abutment comprises a pin which projects into the interior of the spring. This secure guidance of the spring even if it is displaced relative to the spring abutment. It is also conceivable that the spring bearing comprises a retaining projection on which the spring is held, in particular with its first spring end. A snap-in and/or latching connection may be provided here, for example.

One variant of the invention may be that the carriage comprises a pusher receptacle, and that the pusher is at least partially received in the pusher receptacle. This results in a compact design. In particular, the pusher receptacle may comprise a receiving space in which the pusher is at least partially received.

Preferably, it may also be provided that the pusher comprises at least one latching element, wherein the pusher receptacle comprises at least one counter latching element, and wherein the pusher is at least partially held in the pusher receptacle by latching the latching elements to the counter latching elements. In this way, the pusher may be easily mounted on the carriage. Also, the pusher may be held securely on the carriage.

It is conceivable that the counter latching elements or the latching elements are designed as slots, and the latching elements or the counter latching elements are designed as projections, for example as latching lugs. Movability of the pusher relative to the carriage may be ensured, for example, if the slots comprise a longer longitudinal extension than the projections.

If it is provided that the pusher receptacle comprises an abutment surface and that the/a spring of the pusher is supported on the abutment surface, a spring force may act between the pusher and the pusher receptacle. In this case, the spring may be supported on the abutment surface, in particular with its/a second spring end.

The pusher receptacle may preferably comprise a support surface, the pusher, in the rest position, being supported on the support surface with a counter-support surface. The pusher may, for example, be supported on the support surface against the pretensioning force of the spring.

In accordance with an advantageous further embodiment of the invention, it is proposed that the trigger is mounted on the housing in a pretensioned manner, and that the pretension counteracts movement of the trigger from the blocking position to the release position. This may ensure that the trigger remains in the blocking position without a deliberate adjustment, in particular without an adjustment due to an overstroke. An undesired triggering of an ejection process may be reliably prevented. In addition, it is achieved that the trigger is reliably returned to the blocking position after it has been moved to the release position. Alternatively or additionally, it may be provided that a support area is provided on the trigger, that a spring retainer is provided on the housing, and that a return spring is acting between the support area and the spring retainer.

One variant of the invention may be such that a guide element is provided on the carriage, that a guide track is provided on the housing, that the guide element is guided on the guide track, that the trigger, in the blocking position, prevents a displacement of the guide element, and in that the trigger, in the release position, releases the displacement of the guide element. The guide element may be provided movably on the carriage. If the trigger prevents the guide element from being displaced in the blocking position, this may also prevent undesired movement of the carriage. For example, the carriage may be held in the retracted position when the guide element is prevented from being displaced. When the trigger, in the release position, releases the displacement of the guide element, a displacement of the carriage from the retracted position, for example towards the ejected position, may also be released. In other words, an ejection operation may be prevented when the trigger is in the blocking position, and an ejection operation may be enabled when the trigger is in the release position.

It is particularly conceivable that the trigger comprises a retainer attachment, that, in the blocking position, the retainer attachment projects into the guide track, and in that, when the trigger is moved into the release position, the retainer attachment is moved out of the guide track at least partially. Consequently, the retainer attachment may at least partially block the guide track in the blocking position of the trigger and at least partially unblock it in the release position. Displacement of the guide element may thus be prevented and/or permitted in a particularly simple manner.

An advantageous implementation variant of the invention may be characterized in that the guide element is held in a detent position when the carriage is in the retracted position and the trigger is in the blocking position, and that the detent position of the guide element is formed by the guide track and by the trigger. In this context, the trigger may preferably comprise a damper in the region of the detent position. The damper may be made of a compliant material, in particular a damping, preferably viscoelastic material, for example a rubber material. Unwanted noise development that may arise when the guide element is moved into the range of the detent position may thus be avoided or at least reduced.

It is conceivable that the detent position is formed by the/a retainer attachment of the trigger and a detent section of the guide track. In this case, the/a damper may preferably be provided on the trigger in the region of the detent position, in particular be accommodated in a damper receptacle of the trigger.

According to a preferred embodiment of the invention, it may be provided that the carriage comprises a pivoted lever, that the/a guide element is provided on the pivoted lever, that the guide element is guided on the/a guide track of the housing, in that the pivoted lever can be pivoted between a pivoted-in position and a pivoted-out position, and in that the pivoted lever is at least partially pivoted-in in the retracted position or in a range of movement of the carriage between the ejected position and the retracted position. The pivoted lever may comprise, for example, a further driver stop that is in contact with the driver at least during parts of a retraction or ejection process. The driver stop and the further driver stop may be provided at a distance from one another. In that the pivoted lever can be pivoted, it may be movable out of a motion trajectory of the driver. In particular, it is conceivable that the further driver stop is pivoted out of the motion trajectory of the driver in the retracted position or in a range of movement of the carriage between the ejected position and the retracted position. This may provide a free run of the driver. During the free run of the driver, for example, a pull-in device, if provided, may act on the movable furniture part to effect and/or support a closing movement.

In the ejected position or in a range of movement of the carriage between the retracted position and the ejected position, the pivoted lever may preferably be pivoted-out. In particular, the further driver stop may then be located in the motion trajectory of the driver. For example, the further driver stop may be in contact with the driver during a closing movement of the movable furniture part.

A variant of the invention may be characterized in that the trigger comprises a first arm portion and a second arm portion, in that the first arm portion and the second arm portion are at an angle to one another, preferably at a right angle, in that the/a retainer attachment is provided on the first arm portion, in that an activation surface for force transmission with the pusher is provided on the second arm portion, the first arm portion preferably being accommodated at least predominantly within the housing, and the second arm portion further preferably projecting at least partially out of the housing. For example, the second arm portion may protrude from the housing through an arm opening of the housing. Accordingly, a space-saving arrangement can be achieved in which the activation surface may nevertheless be accessible outside the housing.

In particular, in the case of wide and/or heavy movable furniture parts, such as wide and/or heavy drawers, it may be desirable to provide a device on each side of the drawer, for example.

According to an advantageous embodiment of the invention, it is therefore proposed that the release of the carriage of a first device from the retracted position can be synchronized with the release of a carriage of a second device. Thus, it may be ensured that the triggering of an ejection process is caused and/or supported by both devices. In particular, it may be prevented that only one of the devices releases the carriage, for example if a user exerts an overstroke not centered on the drawer.

Specifically, it may be provided that the movement of the trigger of the first device can be synchronized with a movement of a trigger of the second device. Here, preferably, the movement of at least one of the triggers may be translatable into a movement of a synchronizing shaft. Further preferably, the movement of at least one of the triggers may be translated into a rotational movement of the synchronizing shaft, wherein in particular the movement of at least one of the triggers is a linear movement.

A simple translation of the movement of the triggers into a movement of the synchronizing shaft may be achieved if a transmission element is provided on the synchronizing shaft, if on at least one of the triggers a transmission counter-element is provided, and if the transmission element and the transmission counter-element translate between the movement of the synchronizing shaft and the movement of at least one of the triggers.

For example, the transmission elements may be formed as projections and the transmission counter-elements as at least partially correspondingly formed receptacles. It is also conceivable that the transmission elements are designed as receptacles and the translation counter-elements as projections. Of course, any number of transmission elements and transmission counter-elements may be provided.

The invention is explained in more detail below with reference to an example of an embodiment shown in the figures. The figures show:

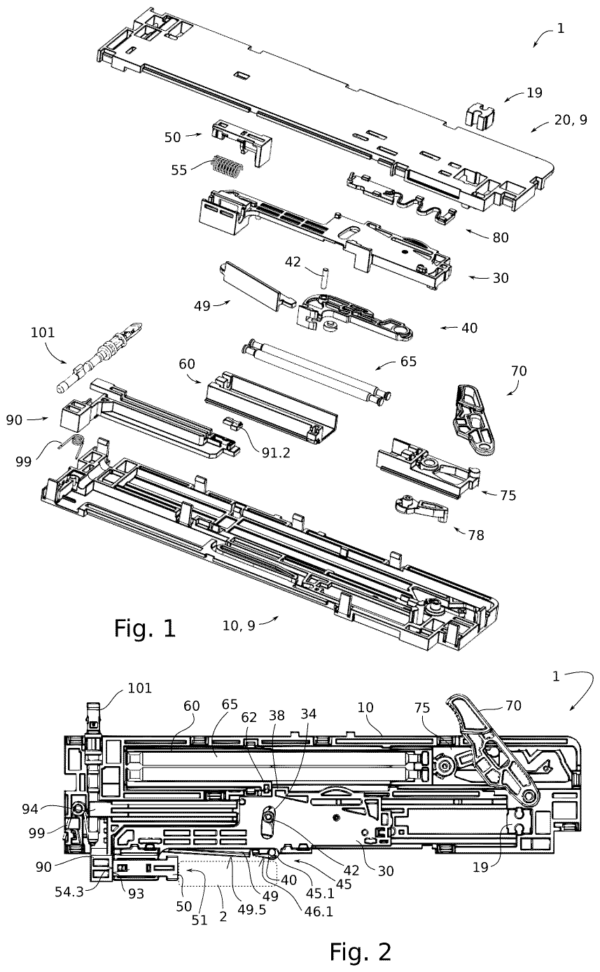

FIG. 1: a schematic exploded view of a device,

FIG. 2: a schematic top view of a device,

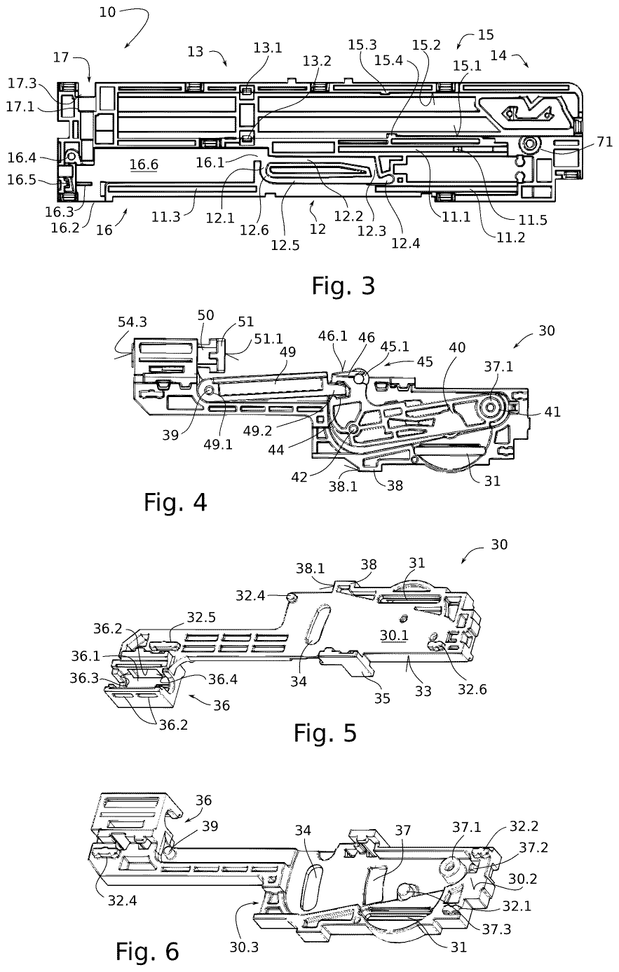

FIG. 3: a schematic top view of a first housing half,

FIG. 4: a schematic top view of a carriage,

FIG. 5: a schematic perspective view of the carriage,

FIG. 6: a further schematic perspective view of the carriage,

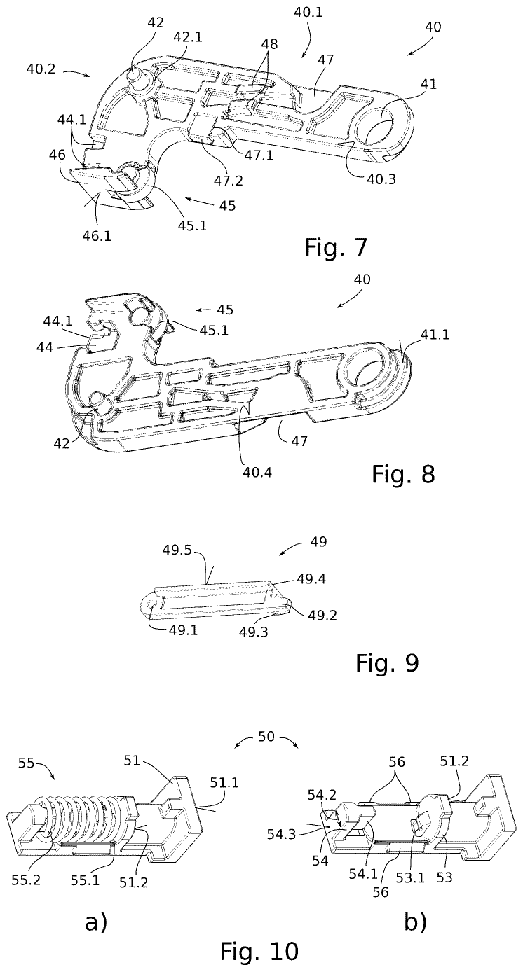

FIG. 7: a schematic perspective view of a pivoted lever,

FIG. 8: a further schematic perspective view of the pivoted lever,

FIG. 9: a schematic perspective view of a deflector,

FIG. 10: schematic perspective views of a pusher,

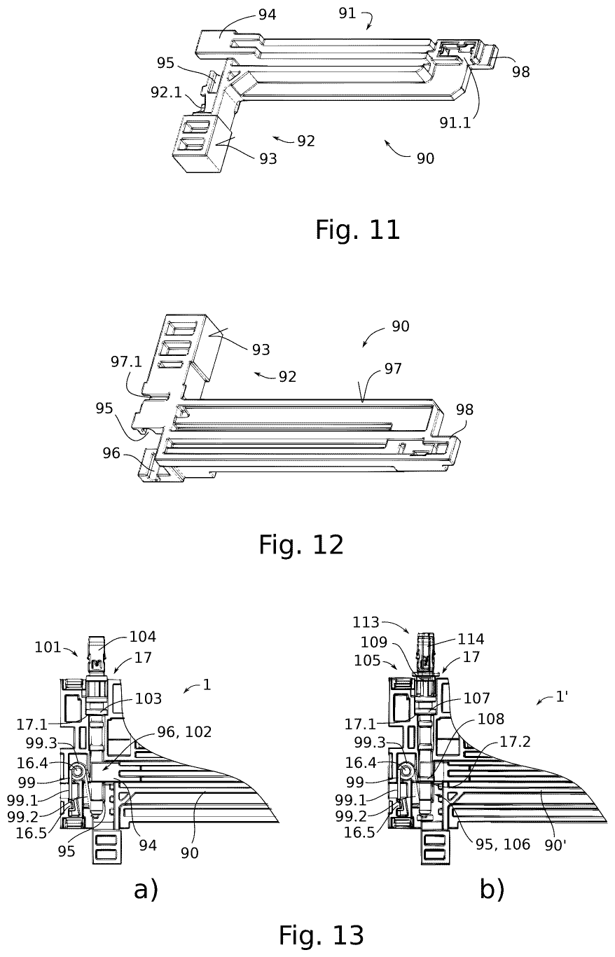

FIG. 11: a schematic perspective view of a trigger,

FIG. 12: another schematic perspective view of the trigger,

FIG. 13: schematic cutaway views of the device with inserted synchronizing elements,

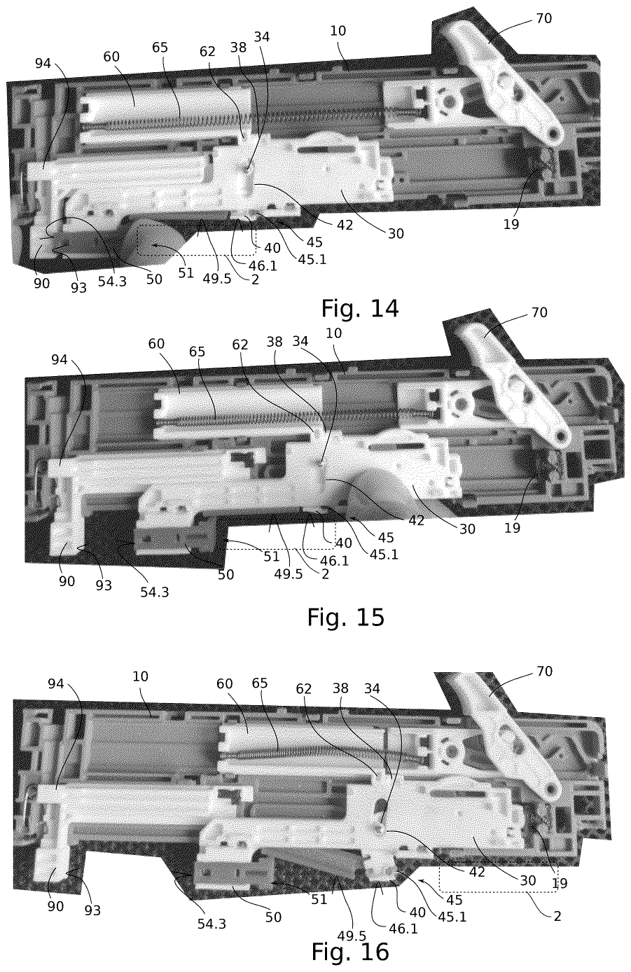

FIG. 14: a schematic top view of the device with the carriage in a retracted position,

FIG. 15: a schematic top view of the device, with the carriage in a range of movement between the retracted position and an ejected position,

FIG. 16: a schematic view of the device, with the carriage in the ejected position,

FIG. 17: a schematic view of the device, with the carriage in a range of movement between the ejected position and the retracted position,

FIG. 18: a further schematic top view of the device, with the carriage in a range of movement between the ejected position and the retracted position,

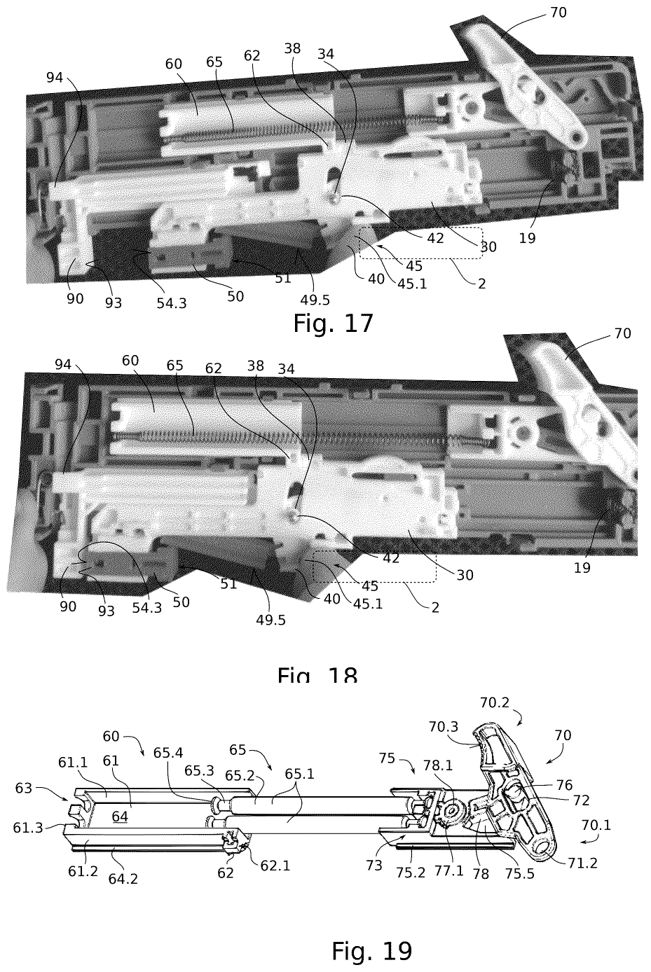

FIG. 19: a schematic perspective view of a spring carriage, a spring element, a bearing element and an adjustment lever,

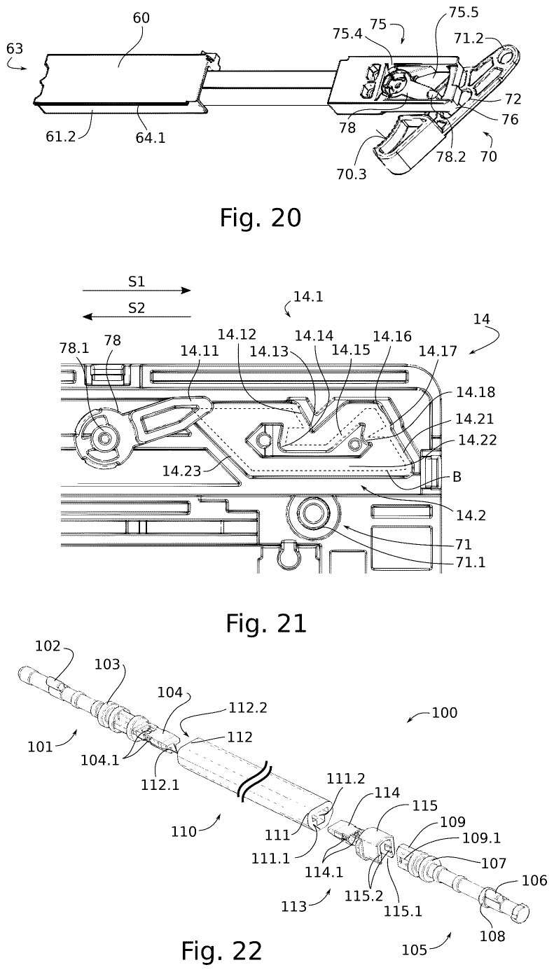

FIG. 20: a further schematic perspective view of the spring carriage, the spring element, the bearing element and the adjustment lever,

FIG. 21: a schematic cutaway view of the area of a guideway of the device,

FIG. 22: a schematic exploded view of a synchronizing shaft,

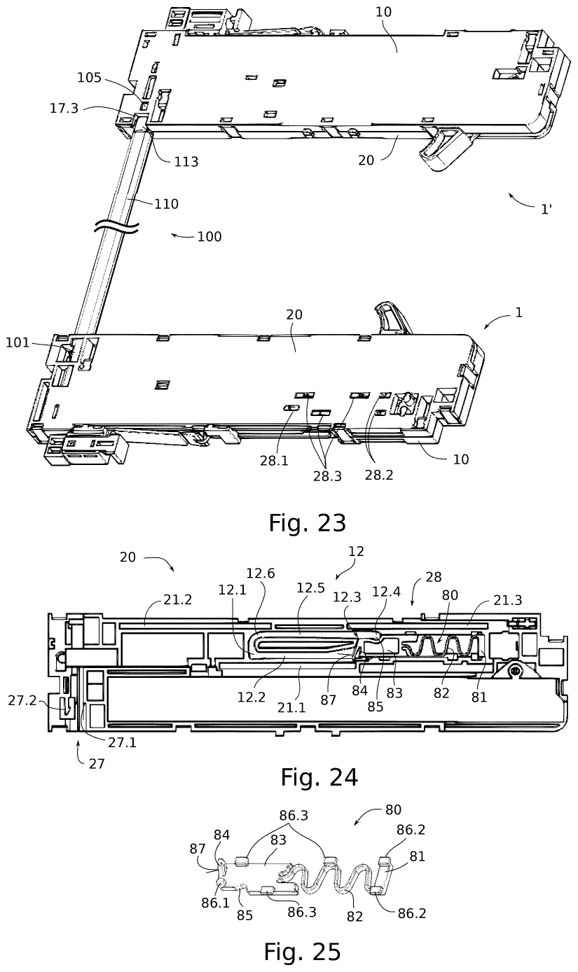

FIG. 23: a schematic perspective view of two devices which are connected to each other via a synchronizing shaft,

FIG. 24: a schematic top view of a device with a latch, and

FIG. 25: a schematic perspective view of the latch.

FIG. 1 shows a schematic exploded view of a device 1. As can be seen from the figure, the device 1 may have a housing 9, which may comprise a first housing half 10 and a second housing half 20. FIG. 2 shows a schematic top view of the device 1, wherein the second housing half 20 is not shown. For example, this may correspond to a situation in which the second housing half 20 has been removed.

As can be seen from FIGS. 1 and 2, the device 1 may comprise a carriage 30 which may be mounted movably relative to the housing 9. The carriage 30 may include a driver stop 51. The driver stop 51 may be provided on a pusher 50, which may be movably supported on the carriage 30. The pusher 50 may be biased by a spring 55 on the carriage 30.

As further shown in FIGS. 1 and 2, the device 1 may further comprise a pivoted lever 40. The pivoted lever 40 may be pivotally mounted to the carriage 30. A further driver stop 45 may be provided on the pivoted lever 40. The pivoted lever 40 may include a guide element 42, which may be configured as a guide pin. Furthermore, a deflector 49 may be provided. The deflector 49 may be pivotably and/or displaceably mounted on the carriage 30, on the one hand, and pivotably and/or displaceably mounted on the pivoted lever 40, on the other hand.

The device 1 may further comprise a trigger 90. The trigger 90 may be movably provided on the housing 9. In particular, the trigger 90 may be biased relative to the housing 9 by a return spring 99.

It may be further understood from FIGS. 1 and 2 that the device 1 may comprise a spring element 65. The spring element 65 may comprise two extension springs, in particular helical springs. The spring element 65 may be mounted on a spring carriage 60 on one side. The spring carriage 60 may be mounted on the housing 9 so as to bemovable, in particular linearly displaceable.

The spring carriage 60 may have a transmission attachment 62. A force may be transmitted between the transmission attachment 62 and a clamp attachment 38 (see FIG. 4) of the carriage 30.

On a side of the spring element 65 opposite the spring carriage 60, the spring element 65 may be supported on a bearing element 75. The bearing element 75 may be movable relative to the housing 9. Thus, a preload of the spring element 65 may be modifiable. As can be seen from FIG. 2, an adjustment lever 70 may be provided for adjusting the bearing element 75. The adjustment lever 70 may, for example, be pivotably mounted on the housing 9.

As can be seen in FIGS. 1, 2 and 22, the device 1 may comprise a first synchronizing element 101 or a second synchronizing element 105. The synchronizing elements 101, 105 will be further discussed elsewhere herein.

FIG. 3 shows a schematic top view of a first housing half 10. As can be seen from the figure, the first housing half 10 may comprise guide receptacles 11.1, 11.2, 11.3, 11.4. The guide receptacles 11.1, 11.2, 11.3, 11.4 may serve to guide the carriage 30. For this purpose, projections 32.1, 32.2, 32.3 may be provided on the carriage 30, as can be clearly seen in FIG. 6. The projections 32.1, 32.2, 32.3 may, for example, be guided in the guide receptacles 11.1, 11.2, 11.3, 11.4. In particular, the guide receptacles 11.1, 11.2, 11.3, 11.4 may be designed as guide tracks.

As can be seen further from FIG. 3, a guide track 12 may further be provided on the first housing half 10. The guide track 12 may serve to guide the pivoted lever 40. For example, as shown in FIG. 7, the pivoted lever 40 may include a guide element 42. The guide element 42 may be pin-shaped. The guide element 42 may be guided in the guide track 12.

Furthermore, it can be seen in FIG. 3 that the first housing half 10 may have a spring carriage guide 13. The spring carriage 60 may be guided on the spring carriage guide 13 in a linearly movable manner. In particular, the spring carriage 60 may be latched to the spring carriage guide 13. For this purpose, latching hooks 13.1, 13.2 may be provided on the spring carriage guide 13, for example. As can be seen from FIGS. 19 and 20, the spring carriage 60 may have guide webs 64.1, 64.2. The guide webs 64.1, 64.2 may, for example, be engaged behind by the latching hooks 13.1, 13.2.

Furthermore, the first housing half 10 may comprise a bearing element guide 15. The bearing element 75 may be guided at the bearing element guide 15. In particular, the bearing element 75 may be guided on walls 15.1, 15.2 of the bearing element guide 15. Movability of the bearing element 75 relative to the housing 9 may be limited, for example, by stops 15.3, 15.4 being provided on the bearing element guide 15.

In the area of the bearing element guide 15, a guideway 14 may also be provided on the first housing half 10, as further shown in FIG. 3. The guideway 14 may serve to guide a guide element 78.2 of the bearing element 75 (see FIG. 20).

The first housing half 10 may include a trigger receptacle 16, as further shown in FIG. 3. The trigger receptacle 16 may serve to receive the trigger 90. As can be seen in FIGS. 11 and 12, the trigger 90 may include a first arm portion 91 and a second arm portion 92. The arm sections 91, 92 may be arranged at right angles to each other, for example. The second arm portion 92 may include an activation surface 93. As can be seen in FIG. 3, the trigger receptacle 16 may have an arm opening 16.2 through which the second arm portion 92 may protrude at least partially from the housing 9. Thus, the activation surface 93 becomes accessible from outside the housing.

At the first arm section 91, the trigger 90 may comprise the retainer attachment 98. The trigger receptacle 16 may have a retainer aperture 16.1, which may be used to connect to a guide track 12. The guide track 12 will be discussed in more detail elsewhere herein. The retainer attachment 98 may be guided through the retainer aperture 16.1 into the region of the guide track 12. Preferably, a damper receptacle 91.1 is provided in the region of the retainer attachment 98 on the trigger 90, in which a damper may be received. The damper may preferably be made of a soft and/or damping material.

The trigger 90 may be movably mounted on the housing 9. In particular, the trigger 90 may rest with a rear side 97 (see FIG. 12) against a bottom 16.6 of the trigger receptacle 16. Furthermore, a guide web 16.3 may be provided on the trigger receptacle 16, which may engage in a recess 97.1 of the trigger 90 (see FIG. 12).

As can be further seen in FIG. 3, a spring bearing 16.4 may be provided on the first housing half 10. The return spring 99 may be held on the spring bearing 16.4. For example, the return spring 99 may be a torsion spring. The return spring 99 may counteract an displacement of the trigger 90. The trigger receptacle 16 may include a spring retainer 16.5, to which a first leg 99.1 of the return spring 99 may be retained. A second leg 99.2 may, for example, be supported on a support area 92.1 of the trigger 90 (see FIG. 11).

FIG. 3 shows that the first housing half 10 may have a shaft opening 17. The shaft opening 17 may receive the synchronizing element 101, 105. For example, a synchronizing element 101, 105 may be inserted or positioned in the shaft opening 17. The shaft opening 17 may have a neck 17.1 against which an abutment portion 103, 107 of the synchronizing element 101, 105 may bear in a rotationally supported manner.

Furthermore, a cutout 17.3 may be provided in the region of the shaft opening 17, as shown in FIG. 23. Preferably, the cutout 17.3 may be provided at the first housing half 10. The cutout 17.3 may represent an opening in the housing wall. Through the cutout 17.3, a part of the shaft opening 17 may be accessible from a direction transverse to a central longitudinal axis of the shaft opening 17. It is also conceivable to provide the cutout 17.3 on the second housing half 20 or on both housing halves 10, 20.

As has already been mentioned, a guide track 12 may be provided on the first housing half 10. The guide element 42 of the pivoted lever 40 (see FIG. 4) may be guided in the guide track 12. The guide track 12 may be designed as a closed-loop revolving guide. A direction of revolution may correspond to the clockwise direction in FIG. 3. The guide track 12 may have a first detent section 12.1 and a second detent section 12.4. Between the first detent section 12.1 and the second detent section 12.4, the guide track 12 may have an ejection section 12.2 and a swivel-out section 12.3 in the direction of revolution. Between the second detent section 12.4 and the first detent section 12.1, the guide track 12 may have a retraction section 12.5 and a swivel-in section 12.6.

The pivoted lever 40 is shown in more detail in FIGS. 7 and 8. The pivoted lever 40 may have an arm section 40.1, which is angularly adjoined by a bent section 40.2. A pivoted lever bearing area 41 may be provided on the arm section 40.1. The pivoted lever bearing area 41 may be in the form of a bore, as shown herein. A pivoted lever detent region 41.1 may be provided in the area of one side of the pivoted lever 40, presently in the area of the pivoted lever lower side 40.4. The pivoted lever detent region 41.1 may, for example, form a surface region set back relative to the pivoted lever lower side 40.4.

The further driver stop 45 may be provided at the bent section 40.2. The further driver stop 45 may be provided as a deflection roller 45.1, which may be rotatably mounted on the pivoted lever 40. Preferably, the deflection roller 45.1 may be made of a soft and/or damping material.

As can be seen further from FIG. 7, a deflection attachment 46 may be provided in the region of the further driver stop 45. The deflection attachment 46 may project beyond the pivoted lever 40 in its thickness, for example in such a way that the deflection attachment 46 projects beyond the pivoted lever upper side 40.3 and/or beyond the pivoted lever lower side 40.4. On a side facing away from the pivoted lever 40, the deflection attachment 46 may include a deflection surface 46.1.

The guide element 42 may be provided on the pivoted lever 40. Preferably, the guide element 42 may be arranged in the transition region between the arm section 40.1 and the bent section 40.2. The guide element 42 may, for example, be pin-shaped. As can be seen from FIGS. 7 and 8, the guide element 42 may project beyond the pivoted lever upper side 40.3 and the pivoted lever lower side 40.4. A guide projection 42.1 may also be provided in the region of the guide element 42. The guide projection 42.1 may have a larger outer diameter than the guide element 42. Preferably, the guide projection 42.1 is arranged concentrically with the guide element 42. The guide projection 42.1 may project less far beyond the pivoted lever upper side 40.3 and/or the pivoted lever lower side 40.4 than the guide element 42.

As FIG. 7 further shows, a guide protrusion 48 may be formed on the pivoted lever upper side 40.3. The guide protrusion 48 may protrude beyond the pivoted lever upper side 40.3. Further, a damper 47.2 may be held on the pivoted lever 40, for example in a damper receptacle 47.1. The damper 47.2 may preferably be made of a soft and/or damping material.

The pivoted lever 40 may further comprise a deflector receptacle 44, for example as present in the form of a recess. Preferably, the deflector receptacle 44 is formed in the region of the bent section 40.2. As can be seen in particular in FIG. 8, the deflector receptacle 44 may have laterally undercut rib receptacles 44.1.

As can be seen in FIG. 6, a pivoted lever bearing attachment 37.1 may be provided on the carriage 30. This may be a cylindrical projection. Furthermore, a latching element 37.2 may be provided in the area of the pivoted lever bearing attachment 37.1. The latching element 37.2 may, for example, be formed as a latching lug.

The carriage 30 may further comprise a guide track 34. Preferably, the guide track 34 may be configured as an arcuate slot through the carriage 30. Furthermore, a guide recess 37 may also be formed on the carriage 30. Preferably, guide track 34 and/or guide recess 37 may be circular arc-shaped, with pivoted lever bearing attachment 37.1 forming the center of the circular arc.

As can be seen in FIG. 4, the pivoted lever 40 may be pivotally mounted on the carriage 30 in that the pivoted lever bearing attachment 37.1 of the carriage 30 is received in the pivoted lever bearing area 41 of the pivoted lever 40. Here, the pivoted lever 40 may be retained on the carriage 30 by latching the latching element 37.2 to the pivoted lever detent region 41.1.

As shown herein, the pivoted lever 40 may be inserted into a recess that may be formed in the region of the carriage underside 30.2 of the carriage 30. The guide element 42 may project beyond the carriage 30 at its carriage underside 30.2. Also, the guide element 42 may extend through the guide track 34 so that it also overhangs the carriage 30 at its carriage upper side 30.1. The guide projection 42.1 may preferably be guided on the guide track 34. The guide protrusion 48 of the pivoted lever 40 may be guided on the guide recess 37 of the carriage 30.

FIG. 4 further shows that the deflector 49 may be mounted in the deflector receptacle 44 of the pivoted lever 40 with a projection 49.2. As can be seen in FIG. 9, the deflector 49 may have extension ribs 49.3 laterally and offset in the region of the projection 49.2. The extension ribs 49.3 may be received in the projections 44.1 of the deflector receptacle 44 of the pivoted lever 40.

As FIG. 9 further shows, the deflector 49 may have a deflector bearing receptacle 49.1 in an end region facing away from the projection 49.2. The deflector bearing receptacle 49.1 may be a bore, as shown here. A deflector ledge 49.4 may be formed on one side of the deflector 49 along its longitudinal extent. The deflector ledge 49.4 may form a deflecting surface 49.5.

The deflector 49 may be pivotably mounted on the carriage 30. For this purpose, a deflector bearing area 39 may be provided on the carriage 30, as can be seen in FIG. 6. The deflector bearing area 39 may be formed as a projection, for example a cylindrical projection. The deflector bearing area 39 may be received in the deflector bearing receptacle 49.1 to form a pivot bearing.

As can be further seen in FIG. 4, a pusher 50 may be provided on the carriage 30. The pusher 50 may form the driver stop 51. The pusher 50 may be received in a pusher receptacle 36 of the carriage 30. The pusher receptacle 36 is shown in more detail in FIG. 5. Accordingly, the pusher receptacle 36 may have a receiving space 36.1 in which the pusher 50 may be at least partially received.

In a region of the pusher receptacle 36 facing the driver stop 51, a support surface 36.4 may be provided which may limit the receiving space 36.1 at least in certain regions. A comparably formed abutment surface 36.3 may be provided opposite. Furthermore, the pusher receptacle 36 may have counter latching elements 36.2 in the region of the receiving space 36.1, which may be formed as recesses and/or apertures as shown.

A possible design of the pusher 50 may be taken from FIG. 10. The pusher 50 may have a spring bearing 53 and a spring abutment 54. A spring 55 may be arranged between the spring bearing 53 and the spring abutment 54. The spring 55 may be a compression spring, for example a helical spring. As can be seen in FIG. 10, the spring 55 may be supported by a first spring end 55.1 on the spring bearing 53. Here, it is conceivable that a retaining projection 53.1 is provided on the spring bearing 53. For example, the retaining projection 53.1 may be designed as a latching element that can be latched to the first spring end 55.1.

The spring abutment 54 may have a transverse extension 54.2 which is less than a transverse extension, in particular an outer diameter of the spring 55 in the region of the second spring end 55.2. As can be seen from FIG. 10a, the spring may consequently project laterally beyond the spring abutment 54.

In the area of the driver stop 51, the pusher 50 may have an actuating surface 51.1 on which a driver 2 can act. A pushing surface 54.3 may be formed at an end of the pusher 50 facing away from the driver stop 51, in particular at the spring abutment 54. Furthermore, a counter-support surface 51.2 facing the driver stop 51 may be provided on the spring bearing 53. The pusher 50 may further comprise latching elements 56, as can be seen more clearly in FIG. 10b.

In an installed state (see FIG. 4), the latching elements 56 of the pusher 50 may be latched with the counter latching elements 36.2 of the carriage 30. In this case, the latching elements 56 and the counter latching elements 36.2 may be designed to ensure movability, particularly linear movability of the pusher 50.

The second spring end 55.2 of the spring 55 of the pusher 50 may come to rest against the abutment surface 36.3 of the pusher receptacle 36 of the carriage 30. In particular, the portions of the second spring end 55.2 projecting beyond the spring abutment 54 may bear against the abutment surface 36.3. The counter-support surface 51.2 of the pusher 50 may bear against the support surface 36.4.

FIG. 23 shows an arrangement of a device 1 and a second device 1′ which are connected to each other by means of a synchronizing shaft 100. An embodiment of the synchronizing shaft 100 is illustrated in FIG. 22 by means of an exploded view. Accordingly, the synchronizing shaft 100 may be made of several parts. In particular, the synchronizing shaft 100 may comprise a first synchronizing element 101 and a second synchronizing element 105, which are connected to each other in a rotationally fixed manner via a connecting part 110.

The synchronizing elements 101, 105 may each be formed as a shaft. Radially projecting transmission elements 102, 106 may be provided on the synchronizer elements 101, 105. As shown in FIG. 22, the transmission elements 102, 106 may be designed as individual circumferentially limited projections extending along at least part of the longitudinal extent of the synchronizing elements 101, 105. However, it is also conceivable that the transmission elements 102, 106 are formed as elements profiled in the circumferential direction. In particular, toothing may also be conceivable.

Furthermore, the synchronizing elements 101, 105 may have abutment portions 103, 107, which may, for example, be formed as shoulders. Further, the second synchronizing element 105 may also have a retaining section 108, which may also be formed as a shoulder.

The first synchronizing element 101 may have a profile section 104 in an end region thereof. As illustrated herein, for example, a T-section may be selected. Latching elements 104.1 may further be provided in the region of the profile section 104.

Deviating therefrom, the second synchronizing element 105 may comprise a coupling section 109 in an end region. The coupling section 109 may, for example, be formed by two surfaces formed parallel to each other and parallel to the longitudinal axis of the second synchronizing element 105. Latching elements 109.1 may be provided on the surfaces of the coupling section 109, which may be formed as recesses, for example.

A connection of the second synchronizing element 105 to the connecting part 110 may be achievable by means of an adapter 113. In this regard, the adapter 113 may comprise a coupling portion 115 having a coupling receptacle 115.1. The coupling receptacle 115.1 may be formed to correspond to the coupling section 109 of the second synchronizing element 105. The coupling receptacle 115.1 may form a coupling section 109 receiving area open in the radial direction on one side. Counter latching elements 115.2 may be formed within the coupling receptacle 115.1. By means of latching the latching elements 109.1 with the counter latching elements 115.2, the adapter 113 may be fixed in radial direction to the second synchronizing element 105.

A profile section 114 may be provided at an end of the adapter 113 facing away from the coupling portion 115. The profile section 114 may advantageously be formed similar to the profile section 104 of the first synchronizing element 101.

The connecting part 110 may be, for example, a cut-to-length section of a bar material or a profile. In its end regions 112, 113, the connecting part 110 may have counter profile sections 111.2, 112.2 on both sides. The counter profile sections 111.2, 112.2 may be formed as recesses in end surfaces 111.1, 112.1 provided at the end regions 112, 113. In particular, the counter profile sections 111.2, 112.2 may be formed to correspond to the profile sections 104, 114. Accordingly, the counter profile sections 111.2, 112.2 may be formed as T-shaped recesses in the longitudinal end surfaces 111.1, 112.1 of the connecting part 110. Conceivably, but not necessarily, that the counter profile sections 111.2, 112.2 may have counter latching elements corresponding to the latching elements 104.1, 114.1. Alternatively or additionally, the latching elements 104.1, 114.1 may also be used to achieve elastic bracing against the walls of the counter profile sections 111.2, 112.2.

FIG. 13 shows sections of devices 1, 1′ with inserted synchronizing elements 101, 105. As can be seen from FIG. 13a, the first synchronizing element 101 may be inserted in the shaft opening 17 of a device 1, for example a first device 1. Thereby, the abutment portion 103 of the first synchronizing element 101 may be supported at the neck 17.1 of the shaft opening 17.

As can be seen from FIG. 13b, the second synchronizing element 105 may be inserted into the shaft opening 17 of a second device 1′. Again, the abutment portion 107 may be supported at the neck 17.1. Furthermore, the retaining section 108 may be supported on the retaining shoulder 17.2 of the shaft opening 17. Accordingly, the second synchronizing element 105 may be held securely in the shaft opening 17 along its longitudinal axis in both directions. In contrast, the first synchronizing element 101 may be retained in only one direction such that it may be inserted into the shaft opening 17 when the housing 9 is closed, particularly when the first housing half 10 and the second housing half 20 are assembled.

The coupling section 109 may be disposed in a region of the cutout 17.3 of the shaft opening 17. Accordingly, the adapter 113 may be enabled to be coupled to the second synchronizing element 105 from a direction transverse to the longitudinal axis thereof. In particular, the adapter 113 may be guidable with its coupling portion 115 through the cutout 17.3 onto the coupling portion 109 of the second synchronizing element 105.

The trigger 90 may comprise a first transmission counter element 95 and a second transmission counter element 96, as can be seen in FIGS. 11 and 12. The transmission counter elements 95, 96 may be provided as recesses formed to correspond to the transmission elements 102, 106. The transmission counter elements 95, 96 may preferably be diametrically opposite each other with respect to the longitudinal axis of the synchronizing elements 101, 105. In particular, it may be provided that the second transmission counter element 96 is provided on an extension piece 94, which may be provided in a transition region between the first arm portion 91 and the second arm portion 92 of the trigger 90.

FIG. 13a shows a first synchronizing element 101 having its transmission element 102 engaged with the second transmission counter element 96 of the trigger 90. Accordingly, the transmission element 102 is oriented to face out of the image plane. A leftward displacement of the trigger 90 in the image plane may correspond to a triggering movement. A movement of the trigger 90 to the left may cause a movement of the transmission element 102 to the left and, accordingly, a rotation of the first synchronizing element 101 about its longitudinal axis.

In contrast, FIG. 13b shows a second synchronizing element 101 having its transmission element 106 engaged with the first transmission counter element 95 of a second trigger 90′ of the second device 1′. The second trigger 90′ may be configured in the same way as the trigger 90, but preferably the second trigger 90′ does not comprise an extension piece 94. Accordingly, it may be provided that the second trigger 90′ comprises only a first transmission counter element 95.

In FIG. 13b, the transmission element 106 is oriented to face into the image plane. An movement of the second trigger 90′ to the left in the image plane may also correspond to a triggering movement. An movement of the second trigger 90′ to the left may cause an movement of the transmission element 106 to the left. However, since the transmission element 106 now points into the image plane, in contrast to the situation shown in FIG. 13a, this results in a direction of rotation of the second synchronizing element 105 which is opposite to that of the first synchronizing element 101.

If two devices 1, 1′ are now arranged opposite each other in a typical installation situation as shown in FIG. 23, this results in a uniform direction of rotation of the synchronizing shaft 100, which is coupled in a rotationally fixed manner to the synchronizing elements 101, 105, during a triggering movement of the two triggers 90, 90′. Accordingly, there is no need to provide a second device 1′ which is mirror-inverted with respect to the first device 1. Rather, two devices 1, 1′ of at least predominantly identical design may be synchronized with one another. Preferably, only two differently designed synchronizing elements 101, 105 need to be used for this purpose. Preferably, but not necessarily, two differently designed triggers 90, 90′ may also be used.

FIGS. 19 and 20 show the spring carriage 60, the spring element 65, the bearing element 75 and the adjustment lever 70 in more detail. As can be seen from the figures, the spring element 65 may comprise one or at least two extension springs 65.1. The extension springs 65.1 may have narrowed regions 65.3 at their respective ends. Head regions 65.4 may adjoin the narrowed regions 65.3, wherein the head regions 65.4 may have an enlarged outer diameter compared to the narrowed regions 65.3.

Spring bearings 63 may be provided on the spring carriage 60 to accommodate the spring element 65. Preferably, the spring carriage 60 may form a spring receiving space 61 in which the spring element 65 is at least partially received. The spring receiving space 61 may be bounded by a bottom 64, two side walls 61.1, 61.2 and a rear wall 61.3. Opposite the rear wall 61.3, preferably in the direction towards the bearing element 75, the spring receiving space 61 may be open.

The spring bearing 63 may be formed as recesses in the rear wall 61.3 corresponding to the narrowed regions 65.3. Preferably, the recesses are open facing away from the bottom 64. Thus, the narrowed regions 65.3 may be easily inserted into the recesses. In FIG. 19, the spring element 65 is not inserted into the spring bearing 63 for better visibility of the spring bearing 63.

In the area of the end of the spring carriage 60 opposite the rear wall 61.3, the transmission attachment 62 may be arranged. As can be seen from the figures, a counter stop surface 62.1 may be formed on the transmission attachment 62. The counter stop surface 62.1 may be in contact with a stop surface 38.1 of the clamp attachment 38 of the carriage 30 (see FIG. 5).

Opposite the spring carriage 60, the spring element 65 may be mounted on the bearing element 75. For this purpose, spring mounts 73 may be provided, which preferably are designed in a comparable manner to the spring mounts 63 of the spring carriage 60.

As can be seen further from FIGS. 19 and 20, the engaging lever 78 may be pivotably mounted on the bearing element 75. For this purpose, an engaging lever bearing 77.1 may be provided on the bearing element 75. For example, the engaging lever bearing 77.1 may be configured as a bore. The engaging lever 78 may have an engaging lever bearing extension 78.1 in an end region, which may be held in the engaging lever bearing 77.1. Preferably, latching elements 75.4 may be provided on the bearing element 75 in the region of the latching lever bearing 77.1. The latching elements 75.4 may, for example, act on a surface on the latching lever 78 in such a way that the latter may be held securely on the latching lever bearing 77.1.

The engaging lever 78 may be received on the bearing element 75 in an engaging lever recess 75.5. The engaging lever recess 75.5 may, in particular, be formed as an aperture and frame a pivot region of the engaging lever 78.

A guide element 78.2 may be provided on the engaging lever 78, preferably at an end facing away from the engaging lever bearing 77.1. The guide element 78.2 may be formed as a projection on the engaging lever 78.

The bearing element 75 may further comprise a transmission element 76. As can be seen in FIG. 19, the transmission element 76 may be formed as a projection on the bearing element 75. Preferably, the transmission element 76 is provided in an end region of the bearing element 75 facing away from the spring mount 73. The transmission element 76 may be guided on a counter transmission element 72 of the adjustment lever 70. As present, the counter transmission element 72 may be a straight slot in the adjustment lever 70.

The adjustment lever 70 may have a bearing side 70.1 on which a lever bearing receptacle 71.2 may be formed. The lever bearing receptacle 71.2 may be designed as a bore. Facing away from the bearing side 70.1, the adjustment lever 70 may further have an operating side 70.2. Preferably, an operating surface 70.3 is provided in the region of the operating side 70.2, on which a user may act.

As already explained, the adjustment lever 70 may be pivotably mounted on the housing 9. For this purpose, a lever bearing projection 71.1 may be provided on the housing 9, in particular on the first housing half 10 (see FIG. 21). Thus, a lever bearing 71 may be formed by receiving the lever bearing projection 71.1 in the lever bearing receptacle 71.2.

As previously mentioned, the guide element 78.2 of the bearing element 75 may be guided on the guideway 14. This is shown in more detail in FIG. 21. Here, for a better overview, only the first housing half 10 and the engaging lever 78 are shown in FIG. 21.

The guideway 14 may be designed as a closed-loop revolving guide and have a tensioning portion 14.1 and a return portion 14.2. The guideway 14 may define a motion trajectory B of the guide element 78.2 when the bearing element 75 is moved relative to the housing 9. Here, a movement in a first adjustment direction S1, which is directed to the right in FIG. 21, may correspond to an increase in the preload of the spring element 65. An movement of the bearing element 75 in the opposite second adjustment direction S2 may correspond to a decrease of the preload of the spring element 65.

The tensioning portion 14.1 may comprise a first detent section 14.11, a second detent section 14.14 and a third detent section 14.18. The detent sections 14.11, 14.14, 14.18 may be configured such that the guide element 78.2 is held thereon against the second adjustment direction S2. Accordingly, a movement of the bearing element 75 in the second adjustment direction S2 may be prevented if the guide element 78.2 is moved into one of the detent sections 14.11, 14.14, 14.18.

Along the motion trajectory B, a first detent section 14.12 may be arranged between the first detent section 14.11 and the second detent section 14.14. Furthermore, a second deflection section 14.15 and a third deflection section 14.16 may be provided between the second detent section 14.14 and the third detent section 14.18. The deflection sections 14.12, 14.15, 14.16 may cause a change in direction of movement of the guide element 78.2. For example, the guide element 78.2 may initially perform a movement in the first adjustment direction S1 when it is moved away from the first detent section 14.11. In other words, the direction of movement of the guide element 78.2 may initially correspond to the direction of movement of the bearing element 75. At the deflection sections 14.12, 14.15, the guide element 78.2 may undergo a change of direction. The engaging lever 78 may pivot in this case.

As can be further seen in FIG. 21, a first intermediate detent section 14.13 may be provided between the first deflection section 14.12 and the second detent section 14.14. Further, a second intermediate detent section 14.17 may be provided between the third deflection section 14.16 and the third detent section 14.18. The intermediate detent sections 14.13, 14.17 may be designed in such a way that the guide element 78.2 is held on them against the first adjustment direction S1. Accordingly, a movement of the bearing element 75 in the first adjustment direction S1 may be prevented if the guide element 78.2 is moved into one of the intermediate detent sections 14.13.

The third detent section 14.18 may be, along the motion trajectory B, followed by the return portion 14.2. For example, the third detent section 14.18 may be followed by a fourth deflection section 14.21. The fourth deflection section 14.21 may be followed by a return section 14.22. Finally, a fifth deflection section 14.23 may be provided, which may establish a connection of the return section 14.2 with the tensioning portion 14.1, in particular with the first detent section 14.11.

As can be seen in particular in FIG. 24, the device 1 may comprise the latch 80. The latch 80 may be mounted on the housing 9, preferably on the second housing half 20. For this purpose, a latch receptacle 28 may be provided on the second housing half 20.

The latch 80 is shown in more detail in FIG. 25. The latch 80 may be an elastic and/or an elastically deformable and/or displaceable element, which preferably has a base member 83. A spring section 82 may be connected to the base member 83. The spring section 82 preferably has an elastically resilient design. As shown in the figures, the spring section 82 may have a meander-shaped profile section. In this way, elastic resiliency may be achieved with a flat design.

The spring section 82 may be followed by a bearing section 81. The bearing section 81 may preferably have retaining projections 86.2. The retaining projections 86.2 may be held, in particular latched, in latch bearing receptacles 28.2 (see FIG. 23) in the region of the latch receptacle 28 of the second housing half 20. Thus, the latch 80 may be supported on the housing 9 against an acting force in the direction from the base member 83 to the bearing section 81.

Furthermore, the latch 80 may have one or more displacement projections 86.3. As can be seen from FIG. 25, displacement projections 86.3 may preferably be provided on the spring section 82 and on the base member 83. The displacement projections 86.3 may be guided on displacement receivers 28.3 (see FIG. 23) in the area of the latch receptacle 28. Preferably, the displacement receivers 28.3 are longer than the displacement projections 86.3, whereby a displaceability of the displacement projections 86.3 may be ensured.

Furthermore, a guide projection 86.1 may be provided on the base member 83, which may be guided in a guide receptacle 28.1 (see FIG. 23) in the area of the latch receptacle 28.

As can be seen from FIG. 25, a deflection surface 87 may be provided on the base member 83. Via the deflection surface 87, a force may be introduced into the latch 80, which may cause an elastic deformation of the latch 80, preferably of the spring section 82, in the direction of the bearing section 81. Preferably, the deflection surface 87 may be provided on a spring projection 84. The spring projection 84 may be formed as an elastically deformable angled section on the base member 83. Accordingly, there is further resiliency of the latch 80 in addition to the resiliency of the spring section 82.

As can be seen in FIG. 24, the latch 80 may be arranged at least partially in the region of the guide track 12. Preferably, the guide track 12 may also be provided on the second housing half 20 for this purpose. The guide element 42 of the pivoted lever 40 may thus be guided on the guide track 12 on the first housing half 10 and on the second housing half 20.

FIG. 24 shows the latch 80 in an undeformed basic position. Here, the latch 80 may preferably rest with its deflection surface 87 against the guide track 12, in particular as shown in such a way that the swivel-out section 12.3 is closed by the latch 80. However, due to the elastic deformability of the latch 80, the swivel-out section 12.3 may be released when the guide element 42 is moved from the ejection section 12.2 into the swivel-out section 12.3.

Furthermore, a detent area 85 may be formed on the latch 80, preferably on the base member 83. The detent area 85 may be designed as a recess. As can be seen from FIG. 24, the detent area 85 may cooperate with the guide track 12 to at least partially form the second detent section 12.4 of the guide track 12. Thus, after the guide element 42 has been displaced by the swivel-out section 12.3, it may be retained at the second detent section 12.4. A return to the swivel-out section 12.3 may be prevented by the latch 80, since in this position the guide element 42 cannot exert a force component on the latch 80 that could displace it toward the bearing section 81.

In the following, an example of the operation of the device 1 will be explained in more detail with reference to an ejection and retraction operation of a movable furniture part.

In FIG. 2, a first state is shown in which the movable furniture part may be in a closed state. The driver 2 may be in contact with the driver stop 51. The carriage 30 is in the retracted position. The preload of the spring element 65 acts on the carriage 30 via the transmission attachment 62 of the spring carriage 60.

The further driver stop 45 is pivoted away from the motion trajectory of the driver 2. Likewise, the deflecting surface 49.5 is pivoted away from the motion trajectory of the driver 2.

The pusher 50 is in a rest position. The trigger 90 is in a blocking position. Here, the retainer attachment 98 projects into the guide track 12. The guide element 42 is located in the first detent section 12.1 and is held there on the retainer attachment 98.

In FIG. 14, a further condition is shown in which a force is exerted by the driver 2 on the driver stop 51. This may correspond to an overstroke exerted by a user on the movable furniture part. As a result, the pusher 50 is moved from its rest position against the pretension of the spring 55 into an adjustment position. By force transmission between the pushing surface 54.3 of the pusher 50 and the activation surface 93 of the trigger 90, the trigger 90 is moved into a release position. In FIG. 14, the trigger 90 is moved to the left in the image plane against the pretension of the return spring 99. This moves the retainer attachment 98 away from the guide track 12. Accordingly, the first detent section 12.1 is released and the guide element 42 may be moved into the ejection section 12.2.

Thus, the trigger 90 and/or the retainer attachment 98 of the trigger 90 may also be construed as a latch that permits pivoting of the pivoted lever 40 from the pivoted-out position to the pivoted-in position and blocks pivoting of the pivoted lever 40 from the pivoted-in position to the pivoted-out position.

Further, the movement of the trigger 90 causes the first synchronizing element 101 to rotate, and the rotation of the first synchronizing element 101 may be transmitted to a second synchronizing element 105 on a second device 1′ by means of the synchronizing shaft 100. Thus, a second coupled device 1′ may also be triggered.

FIG. 15 shows a situation in which the carriage 30 is in a range of movement between the retracted position and an ejected position. The carriage 30 has been moved while reducing the preload of the spring element 65. The guide element 42 is located in the ejection section 12.2. The further driver stop 45 is further pivoted away from the motion trajectory of the driver 2. As can be seen further from FIG. 15, the trigger 90 is again moved back to its blocking position by the pretension of the return spring 99. The pusher 50 is moved back to its rest position by the pretension of the spring 55. Via the driver stop 51, the movement of the carriage 30 is transmitted to the driver 2, whereby the movable furniture part is ejected.

FIG. 16 shows the ejected position of the carriage 30. Advantageously, a plug 19 made of a flexible material may be provided on the housing 9, which may at least reduce a hard stopping of the carriage 30 in the ejected position. After passing through the ejection section 12.2, the guide element 42 has been displaced along the swivel-out section 12.3. The driver 2 is no longer located in the area of the further driver stop 45 and the deflecting surface 49.5. Accordingly, the driver 2 does obstruct a pivoting out of the pivoted lever 40.

According to FIG. 16, the guide element 42 is now in the second detent section 12.4. Here, the guide element 42 has elastically deformed the latch 80 during its displacement along the swivel-out section 12.3 to briefly release the swivel-out section 12.3. After the latch 80 is reset, the swivel-out section 12.3 is blocked again and the guide element 42 is prevented from returning to the swivel-out section 12.3. The pivoted lever 40 has been moved to an pivoted-out position by the displacement of the guide element 42 at the swivel-out section 12.3. Thus, the further driver stop 45 is now in the motion trajectory of the driver 2.

The movable furniture part may now be further ejected by the momentum of the ejection movement and/or by manual extraction. This causes the driver 2 to move further away from the further driver stop 45 along its motion trajectory.

The ejected position shown in FIG. 16 may represent a waiting position of the device 1. If the movable furniture part is now moved again in the closing direction, the driver 2 meets the further driver stop 45, as shown in FIG. 17. The pivoted lever 40 is in the pivoted-out position and the further driver stop 45 is arranged in the motion trajectory of the driver 2.

When the movable furniture part is acted upon further, the carriage 30 is moved in the direction of the retracted position via the contact between the driver 2 and the further driver stop 45. The preload of the spring element 65 is increased. The guide element 42 leaves the second detent section 12.4 and is displaced along the retraction section 12.5.

According to FIG. 18, the guide element 42 has reached the swivel-in section 12.6 after passing through the swivel-in section 12.5. However, the pivoted lever 40 is still in the pivoted-out position. Accordingly, the further driver stop 45 is still in the motion trajectory of the driver 2. When further force is applied by the driver 2 to the further driver stop 45, the guide element 42 is displaced along the swivel-in section 12.6 and reaches the first detent section 12.1. Here, the deflection roller 45.1 may advantageously roll on the driver 2. Due to the design of the pivoted lever 40, the application of force by the driver 2 is advantageously translated into a torque that assists the swing-in movement.

When the guide element 42 has reached the first detent section 12.1, the pivoted lever 40 is in the pivoted-in position. Accordingly, the further driver stop 45 has swung away from the motion trajectory of the driver 2. Now the driver 2 may be moved towards the driver stop 51, whereby the driver 2 is released from the force of the spring element 65. In other words, this results in a free run of the driver 2 towards the end of the drawing-in movement.

It is conceivable that a drawing-in device is provided, which acts on the movable furniture part at least during the free run and at least supports the completion of the drawing-in movement. Alternatively, the driver 2 may also only be moved manually into the final closed position during the free run.

When the driver 2 is moved back into the vicinity of the driver stop 51, the initial position shown in FIG. 2 is reached again.

In the following, an example of the operation of the adjustment of the preload of the spring element 65 is explained in more detail.

In FIG. 2, a setting corresponding to a minimum pre-adjusted preload of the spring element 65 is shown. Accordingly, the guide element 78.2 of the engaging lever 78 is located in the area of the first detent section 14.11 of the guideway 14.

To increase the preload, a user may now act on the operating surface 70.3 of the adjustment lever 70 substantially in the first adjustment direction S1. This causes the adjustment lever 70 to pivot. By means of the transmission element 76 of the bearing element 75 and the counter transmission element 72 of the adjustment lever 70, the pivoting of the adjustment lever 70 is translated into an adjustment of the bearing element 75. Accordingly, the bearing element 75 may be moved in the first adjustment direction S1.

Consequently, the guide element 78.2 is also initially moved along the first adjustment direction S1, until it reaches the first deflection section 14.12. There it is deflected towards the first intermediate detent section 14.13. When the guide element 78.2 reaches the area of the first intermediate detent section 14.13, it is held there against the first adjustment direction S1. Thus, the user is facing a resistance opposed to a further adjustment of the adjustment lever 70 in the first adjustment direction S1. When the user now ends application of force to the operating surface 70.3, the guide element 78.2 may be moved into the second detent section 14.14 under the action of the force of the spring element 65. Thus, the preload of the spring element 65 may be increased by one step compared to the situation shown in FIG. 2. Consequently, the user receives haptic feedback that a higher level of preload has been reached.

In a comparable manner, a further level of increased preload may be achieved by the user again acting on the operating surface 70.3 of the adjustment lever 70. Accordingly, the guide element 78.2 may now be moved from the second detent section 14.14 via the second deflection section 14.15 and the third deflection section 14.16 into the second intermediate detent section 14.17. From the second intermediate detent section 14.17, the guide element 78.2 again moves to the third detent section 14.18 when the user stops applying force to the operating surface 70.3. The third stage of adjustable pretension of the spring element 65 has thus been reached.

From the third detent section 14.18, the guide element 78.2 may be displaced into the range of the fourth deflection section 14.21 when a further force is applied to the operating surface 70.3. The guide element 78.2 thus enters the return portion 14.2. Along the return portion 14.2, the guide element 78.2 may initially be moved in the second adjustment direction S2 while reducing the pretension of the spring element 65. At the fifth deflection section 14.23, the guide element 78.2 may now be returned to the first detent section 14.11. Thus, the first stage of the adjustable pretension as shown in FIG. 2 is achieved again.

In the following, a possible assembly procedure of a device 1 will be explained in more detail.

For example, the return spring 99 may first be connected to the spring bearing 16.4. Here, a first leg 99.1 is inserted into a spring retainer 16.5. A second leg 99.2 may initially remain free. At the trigger 90, the damper may be inserted into the damper receptacle 91.1. Now the trigger 90 may be inserted into the trigger receptacle 16. Here, the second leg 99.2 of the return spring 99 may first be inserted into the support area 92.1 of the trigger 90. When the trigger 90 is inserted into the trigger receptacle 16, the return spring 99 is also securely held.

Further, the spring carriage 60 may be inserted into the spring carriage guide 13. Here, the latching hooks 13.1, 13.2 may be engaged with the guide webs 64.1. In the following, the spring element 65 may already be inserted on one side into the spring bearing 63 of the spring carriage 60.

It is conceivable to next preassemble the bearing element 75. Here, the engaging lever bearing extension 78.1 of the engaging lever 78 may be connected to the engaging lever bearing 77.1 of the bearing element 75. The preassembled bearing element 75 may then be inserted into the bearing element guide 15. Preferably, the guide element 78.2 is inserted here into the first detent section 14.11 of the guideway 14.

Now the adjustment lever 70 with its lever bearing receptacle 71.2 may be placed on the lever bearing projection 71.1 of the housing 9. Here, the counter transmission element 72 of the adjustment lever 70 may be placed on the transmission element 76 of the bearing element 75.

The spring element 65 may now be inserted into the spring mount 73 of the bearing element 75.

In a next step, it is conceivable to preassemble the carriage 30 with the pusher 50 and the pivoted lever 40. The deflection roller 45.1 may first be mounted on the pivoted lever 40. Also, the damper 47.2 may be inserted into the damper receptacle 47.1. The pivoted lever 40 may then be mounted with the pivoted lever bearing area 41 on the pivoted lever bearing attachment 37.1 of the carriage 30.

The pusher 50 may first be provided with the spring 55. For this purpose, the spring 55 may first be fitted with its second spring end 55.2 onto the pin 54.1. Subsequently, the first spring end 55.1 may be supported on the spring bearing 53. Finally, the pusher 50 may be inserted into the pusher receptacle 36 of the carriage 30. Advantageously, the pusher 50 may be latched with its latching elements 56 to the counter latching elements 36.2 of the pusher receptacle 36.

Now the carriage 30 may be inserted with its projections 32.1, 32.2, 32.3 into the guide receptacles 11.1, 11.2, 11.3, 11.4. Here, the clamp attachment 38 of the carriage 30 may also be engaged with the transmission attachment 62 of the spring carriage 60. If necessary, the spring carriage 60 might need to be displaced slightly along against the pretension of the spring element 65.

The pivoted lever 40 may be in its pivoted-out position when the carriage 30 is inserted. Thus, the guide element 42 may be inserted into the retraction section 12.5 or the second detent section 12.4. Finally, the plug 19 may be inserted.

It is now conceivable to insert the latch 80 into the latch receptacle 28 in a further step. To do this, the retaining projections 86.2 may first be engaged with the latch bearing receptacles 28.2. Subsequently, the displacement projections 86.3 may be engaged with the displacement receivers 28.3.

If a device 1 having a first synchronizing element 101 and a trigger 90 and a second device 1′ having a second synchronizing element 105 and preferably a second trigger 90′ are provided, the further assembly steps may differ between the first and the second device 1.

The first device 1 may now be completed by bringing the first housing half 10 into connection with the second housing half 20. Preferably, latching elements are provided on the first housing half 10 and the second housing half 20 for this purpose.

The first synchronizing element 101 may be inserted into the shaft opening 17 of the first device 1 in a later step. For this purpose, the first synchronizing element 101 is inserted such that the transmission element 102 is in an orientation such that it may be engaged with the second transmission counter element 96.

Preferably, the second synchronizing element 105 may be inserted into the second device 1′ before the first housing half 10 and the second housing half 20 are connected. The retaining section 108 is held at the retaining shoulder 17.2 of the shaft opening 17 of the second device 1′. The transmission element 106 of the second synchronizing element 105 is engaged with the first transmission counter element 95 of the second trigger 90′. It is now conceivable to complete the assembly of the second device 1′ by connecting the first housing half 10 to the second housing half 20.

The first device 1 and the second device 1′ may now be mounted opposite each other on a movable furniture part or a furniture body. If synchronization between the devices 1, 1′ is intended, the first synchronizing element 101 may now first be inserted with its profile section 104 into the counter profile section 112.2 of the connecting part 110. The adapter 113 may be inserted with its profile section 114 into the opposite counter profile section 111.2 of the connecting part 110. Subsequently, the first synchronizing element 101 may be inserted into the shaft opening 17 of the first device 1 in the manner described above.

Now, the adapter 113 with its coupling section 115 may be engaged with the coupling section 109 of the second synchronizing element 105 of the second device 1′. Advantageously, the coupling receptacle 115.1 is thereby placed on the coupling section 109 in a direction that is substantially perpendicular to the longitudinal axis of the second synchronizing element 105. Hence, the coupling portion 115 of the adapter 113 may pass through the cutout 17.3 of the shaft opening 17.

As shown above, a device 1 for ejecting a movable furniture part is provided. The device 1 is designed to effect and/or support the ejection by force transmission between a driver stop 51 of the device 1 and a driver 2. The device 1 comprises a housing 9 and a carriage 30 movable relative to the housing 9. The carriage 30 is movable between a retracted position and an ejected position. A trigger 90 is provided which is movable between a blocking position and a release position. Actuation of the trigger 90 into the release position releases a movement of the carriage 30 from the retracted position. The carriage 30 comprises a pusher 50. The pusher 50 is movable relative to the carriage 30. The pusher 50 comprises the driver stop 51. The trigger 90 can be actuated by moving the pusher 50 from a rest position to an adjustment position.

1-15. (canceled)

16. A device for ejecting a movable furniture part, wherein the device is configured to effect and/or support an ejection by force transmission between the device and a driver, the device comprising:
a housing;
a carriage movable between a retracted position and an ejected position relative to the housing;
a pusher movable relative to the carriage between a rest position and an adjustment position, the pusher including a driver stop arranged such that the force transmission is between the driver stop and the driver; and
a trigger movable between a blocking position and a release position, wherein actuation of the trigger into the release position releases a movement of the carriage from the retracted position, and wherein the trigger can be actuated by moving the pusher from the rest position to the adjustment position.

17. The device of claim 16, wherein:
the pusher includes an actuating surface defined on the driver stop, and the pusher includes a pushing surface opposite from the actuating surface, the pushing surface being configured to actuate the trigger.

18. The device of claim 16, wherein:
the pusher is mounted on the carriage with a pretension and the pretension counteracts movement of the trigger from the rest position into the adjustment position.

19. The device of claim 16, wherein:
the pusher includes a spring bearing, a spring abutment and a spring having a first spring end engaging the spring bearing and a second spring end engaging the spring abutment.

20. The device of claim 19, wherein:
the spring abutment has a transverse extension width and the second spring end extends transversely beyond the transverse extension width of the spring abutment.

21. The device of claim 20, wherein:
the spring is a helical spring having an outer diameter larger than the transverse extension width of the spring abutment.

22. The device of claim 16, wherein:
the pusher includes at least one latching element;
the carriage includes a pusher receptacle including at least one counter latching element; and
the pusher is at least partially received in the pusher receptacle and the pusher is at least partially held in the pusher receptacle by latching the at least one latching element to the at least one counter latching element.

23. The device of claim 22, wherein:
the pusher receptacle includes an abutment surface and a support surface;
the pusher includes a counter-support surface; and
the pusher includes a spring including a spring end supported on the abutment surface;
wherein when the pusher is in the rest position the counter-support surface of the pusher is supported on the support surface of the pusher receptacle.

24. The device of claim 16, wherein:
the trigger is mounted on the housing with a pretension counteracting movement of the trigger from the blocking position into the release position.

25. The device of claim 16, wherein:
the trigger includes a support area;
the housing includes a spring retainer; and
the device further includes a return spring acting between the support area and the spring retainer.

26. The device of claim 16, wherein:
the housing includes a guide track;
the carriage includes a guide element guided on the guide track; and
the trigger in the blocking position prevents a displacement of the guide element, and the trigger in the release position releases the displacement of the guide element.

27. The device of claim 26, wherein:
the trigger includes a retainer attachment configured such that in the blocking position the retainer attachment projects into the guide track and in the release position the retainer attachment is at least partially moved out of the guide track.

28. The device of claim 26, wherein:
the guide element is held in a detent position formed by the guide track and the trigger when the carriage is in the retracted position and the trigger is in the blocking position.

29. The device of claim 28, wherein:
the trigger includes a retainer attachment configured such that in the blocking position the retainer attachment projects into the guide track and in the release position the retainer attachment is at least partially moved out of the guide track;
the detent position is formed by the retainer attachment of the trigger and a detent section of the guide track; and
the trigger includes a damper received in a damper receptacle of the trigger adjacent to the retainer attachment.

30. The device of claim 16, wherein:
the housing includes a guide track; and
the carriage includes a pivoted lever, the pivoted lever including a guide element guided on the guide track, the pivoted lever being pivoted between a pivoted-in position and a pivoted-out position, wherein the pivoted lever is at least partially pivoted-in in the retracted position of the carriage and the pivoted lever is pivoted-out in the ejected position of the carriage.

31. The device of claim 16, wherein:
the trigger includes a first arm portion and a second arm portion arranged at an angle to the first arm portion, the second arm portion including an activation surface for force transmission with the pusher, wherein the first arm portion is at least predominantly accommodated within the housing and wherein the second arm portion projects at least partially out of the housing.

32. The device of claim 16 being a first device, in combination with:
a second device; and
a synchronizing shaft configured to synchronize the release of the carriage of the first device with a release of a carriage of the second device, such that a movement of the trigger of the first device is synchronized with a movement of a second trigger of the second device, wherein a linear movement of at least one of the triggers is translated into a rotational movement of the synchronizing shaft.

33. The combination of claim 32, wherein:
the synchronizing shaft includes a transmission element; and
at least one of the triggers includes a transmission counter-element, wherein the linear movement of at least one of the triggers moves the transmission counter-element against the transmission element to rotate the synchronizing shaft.
